(19) United States
(12) Patent Application Publication
(10) Pub. No.: US 2006/0190740 A1
(43) Pub. Date: Aug. 24, 2006

(54) Contents utilization system, contents utilization device and contents utilization information storage device

(76) Inventors: Yoshihiro Hori, Gifu-City (JP); Takatoshi Yoshikawa, Osaka (JP)

Correspondence Address: MCDERMOTT WILL & EMERY LLP, 600 13TH STREET, N.W., WASHINGTON, DC, 20005-3096, US

(21) Appl. No.: 11/343,281

(22) Filed: Jan. 31, 2006

(30) Foreign Application Priority Data
Jan. 31, 2005 (JP) JP 2005-023957

(51) Int. Cl. G06F 12/14

(52) U.S. Cl. 713/189

(57) ABSTRACT

A contents utilization device according to the present invention determines whether or not digital contents are utilized, and restores license data to a state before update thereof if it is determined the digital contents are not utilized. Specifically, the license data includes usage rules for the digital contents and the like and is updated according to output of the digital contents.

### CROSS REFERENCE TO RELATED APPLICATIONS

This application is based upon and claims the benefit of priority from the prior Japanese Patent Applications No. P2005-023957 filed on Jan. 31, 2005; the entire contents of which are incorporated herein by reference.

### BACKGROUND OF THE INVENTION

1. Field of the Invention

The present invention relates to a contents utilization system, a contents utilization device and a contents utilization information storage device, which utilize encrypted digital contents by acquiring the digital contents and contents utilization information including usage rules for the digital contents.

2. Description of the Related Art

Along with spread of a communication network typified by the Internet, and sophisticated features and high performance of devices, a so-called DRM (digital rights management) technology has recently attracted attention. Specifically, the DRM technology enables digital contents such as music data, video data and game programs (hereinafter referred to as contents when appropriate) to be freely delivered to a user while protecting copyright thereof.

As an example of the DRM technology, there have been known that encrypted digital contents are stored in a storage device (for example, a memory card and a removable hard disk drive which can be removed from a device and the like) together with “contents utilization information” (hereinafter referred to as CUI when appropriate) including a contents key, usage rules indicating the number of times that utilization (reproduction), copy and the like of the digital contents can be executed (for example, “UDAC-MB”, URL: http://www.udac-consortium.org/technology/index-e.html, http://www.udac-consortium.org/technology/3/index-e.html#3).

Specifically, in order to prevent unauthorized acquisition of CUI, a storage device (a contents utilization information storage device) stores the CUI in Tamper Resistant Module provided therein.

The CUI stored in Tamper Resistant Module is encrypted and then transmitted to a contents reproduction device which receives and reproduces (or executes) digital contents and a contents recording device which copies the digital contents to another recording medium (the contents reproduction device and the contents recording device are hereinafter collectively referred to as a “contents utilization device”).

The contents utilization device decrypts digital contents by use of a contents key included in CUI received from the storage device, and reproduces or copies the digital contents.

Moreover, in the case where the storage device transmits the CUI to the contents utilization device, the storage device updates the contents of the CUI based on usage rules for the digital contents.

For example, in the usage rules, if copy of the digital contents is allowed up to twice, the storage device transmits CUI allowing copy to the contents utilization device, and updates the contents of the CUI corresponding to the digital contents. Specifically, the remaining number of times that the digital contents can be copied is updated to 1.

### BRIEF SUMMARY OF THE INVENTION

However, the conventional DRM technology described above has the following problems. Specifically, there is a problem that, even if the digital contents are never utilized after the contents utilization device receives the CUI, the contents of the CUI are updated at the storage device.

For example, there is a problem that, even if digital contents are never utilized after the contents utilization device receives CUI allowing copy of the digital contents, the number of times that the digital contents can be copied is reduced.

Similarly, there is a problem that the contents of the CUI are also updated at the storage device in the following cases, including: (1) the case where only a part of the digital contents is utilized, such as listening to music data, for example, in the contents utilization device (so-called intro scan and the like); (2) the case where the contents utilization device cannot properly receive the CUI due to trouble with a communication path between the contents utilization device and the storage device; (3) the case where copy of digital contents to another recording medium fails; and the like.

Accordingly, the present invention was made in consideration of the foregoing circumstances. It is an object of the present invention to provide a contents utilization system, a contents utilization device and a contents utilization information storage device, which can restore contents of contents utilization information managed by a storage device to a state before transmission if digital contents are not properly utilized by use of the contents utilization information transmitted by the storage device.

In order to solve the above problems, the present invention has the following aspects. A first aspect of the present invention is a contents utilization system including: a contents utilization device which utilizes encrypted digital contents with a contents utilization information including a contents key for decrypting the encrypted digital contents and a usage rule for the encrypted digital contents; and a contents utilization information storage device which stores the contents utilization information and updates the usage rule of the stored contents utilization information according to output of the stored contents utilization information to the contents utilization device. The contents utilization device includes: log storage unit which stores a contents utilization information identifier for identifying the contents utilization information and the usage rule; a utilization determination unit which determines whether or not the digital contents are utilized; and a restoration request unit which requests restoration of the stored contents utilization information to a state before update thereof if the utilization determination unit determines that the digital contents are not utilized, and transmits the contents utilization information identifier and the usage rule, both of which are stored in the log storage unit, to the contents utilization information storage device. Moreover, the contents utilization information storage device includes: a rewrite determination unit which determines whether or not to rewrite the stored contents utilization information based on whether or not the contents utilization information identifier transmitted from the restoration request unit coincides with the contents utilization information identifier included in the stored contents utilization information; and a rewrite unit which rewrites the usage rule included in the stored contents utilization information into the usage rule transmitted by the restoration request unit based on a result of determination by the rewrite determination unit.

According to the aspect described above, if it is determined that digital contents are not utilized in the contents utilization device (for example, a small music player) even though the right to utilize the digital contents (reproduction, copy and the like) is acquired, the contents utilization device requests the contents utilization information storage device (for example, the storage device) to restore the contents utilization information received from the contents utilization information storage device to a state before update thereof.

Moreover, in the contents utilization information storage device, it is determined whether or not contents of contents utilization information received from the contents utilization device coincide with the updated and stored contents utilization information (the stored contents utilization information) in response to a restoration request, and the contents utilization information is restored to a state before update thereof.

Specifically, according to the aspect described above, if the digital contents are not properly utilized by use of the contents utilization information transmitted by the storage device, the contents of the contents utilization information managed by the storage device can be restored to a state before transmission thereof.

A second aspect of the present invention according to the first aspect of the present invention is that the rewrite unit changes the stored contents utilization information into a state where output is allowed together with rewrite of the usage rule, in either state where output of the stored contents utilization information is allowed or prohibited before the rewrite of the usage rule.

A third aspect of the present invention according to one of the first and second aspects of the present invention is that the contents utilization device further includes a utilization device side cipher processor which encrypts a TX information transmitted to and decrypts an RX information received from the contents utilization information storage device, the contents utilization information storage device further includes a storage device side cipher processor which encrypts the RX information transmitted to and the TX information received from the contents utilization device, and generates a storage device side temporary key, and the information identifier and the usage rule, both of which are encrypted by use of the storage device side temporary key are transmitted from the contents utilization device to the contents utilization information storage device.

A fourth aspect of the present invention is a contents utilization device which utilizes digital contents by receiving a contents utilization information including a usage rule for the digital contents from a contents utilization information storage device which stores the contents utilization information and updates the usage rule of the stored contents utilization information according to output of the stored contents utilization information. The contents utilization device includes: a log storage unit which stores a contents utilization information identifier for identifying the contents utilization information and the usage rule; a utilization determination unit which determines whether or not the digital contents are utilized; and a restoration request unit which requests restoration of the stored contents utilization information to a state before update thereof if the utilization determination unit determines that the digital contents are not utilized, and transmits the contents utilization information identifier and the usage rule, both of which are stored in the log storage unit, to the contents utilization information storage device.

A fifth aspect of the present invention according to the fourth aspect of the present invention is that the contents utilization device further includes a utilization device side cipher processor which encrypts a TX information transmitted to and decrypts an RX information received from the contents utilization information storage device. Moreover, the restoration request unit transmits the contents utilization information identifier and the usage rule, both of which are encrypted with a temporary key that is temporarily generated in the contents utilization information storage device, are transmitted to the contents utilization information storage device.

A sixth aspect of the present invention is a contents utilization information storage device which stores a contents utilization information including a usage rule for digital contents and updates the usage rule of the stored contents utilization information according to output of the stored contents utilization information to a contents utilization device which utilizes the digital contents. The contents utilization information storage device includes: a rewrite determination unit which receives a contents utilization information identifier for identifying the contents utilization information transmitted from the contents utilization device, and determines whether or not to rewrite the stored contents utilization information based on whether or not the received contents utilization information identifier coincides with the contents utilization information identifier included in the stored contents utilization information; and a rewrite unit which rewrites the usage rule included in the stored contents utilization information into the usage rule transmitted from the contents utilization device, based on a result of determination by the rewrite determination unit.

A seventh aspect of the present invention according to the sixth aspect of the present invention is that the rewrite unit changes the stored contents utilization information into a state of where output is allowed together with rewrite of the usage rule, in either state where output of the stored contents utilization information is allowed or prohibited before the rewrite of the usage rule.

An eighth aspect of the present invention according to one of the sixth and seventh aspects of the present invention is that a storage device side cipher processor which encrypts a TX information transmitted to and an RX information received from the contents utilization device and generates a temporary key. Moreover, the usage rule encrypted with the temporary key is transmitted from the contents utilization device.

Specifically, according to the aspects of the present invention, it is possible to provide a contents utilization system, a contents utilization device and a contents utilization information storage device, which can restore contents of contents utilization information managed by a storage device to a state before transmission thereof if digital contents are not properly utilized by use of the contents utilization information transmitted by the storage device.

### BRIEF DESCRIPTION OF THE DRAWINGS

FIG. 1 is a schematic diagram of a contents utilization system according to an embodiment of the present invention.

FIG. 2 is a schematic logic block diagram of a contents recording device according to the embodiment of the present invention.

FIG. 3 is a schematic logic block diagram of a contents reproduction device according to the embodiment of the present invention.

FIG. 4 is a schematic logic block diagram of a storage device according to the embodiment of the present invention.

FIG. 5 is a logic block diagram of a cipher engine included in the contents reproduction device according to the embodiment of the present invention.

FIG. 6 is a logic block diagram of a cipher engine included in the storage device according to the embodiment of the present invention.

FIG. 7 is a view schematically showing an overall operation flow of the contents utilization system according to the embodiment of the present invention.

FIG. 8 is a view showing a connection processing flow executed in the contents utilization system according to the embodiment of the present invention.

FIG. 9 is a view showing the connection processing flow executed in the contents utilization system according to the embodiment of the present invention.

FIG. 10 is a view showing a reconnection processing flow executed in the contents utilization system according to the embodiment of the present invention.

FIG. 11 is a view showing a read transfer processing flow executed in the contents utilization system according to the embodiment of the present invention.

FIG. 12 is a view showing the read transfer processing flow executed in the contents utilization system according to the embodiment of the present invention.

FIG. 13 is a view showing a restoration transfer processing flow executed in the contents utilization system according to the embodiment of the present invention.

FIG. 14 is a view showing the restoration transfer processing flow executed in the contents utilization system according to the embodiment of the present invention.

### DESCRIPTION OF THE PREFERRED EMBODIMENTS

Next, embodiments of the present invention will be described. Note that, in the following description of the drawings, the same or similar parts will be denoted by the same or similar reference numerals. However, it should be noted that the drawings are conceptual and ratios of respective dimensions and the like are different from actual ones.

Therefore, specific dimensions and the like should be determined by taking into consideration the following description. Moreover, as a matter of course, also among the drawings, there are included portions in which dimensional relationships and ratios are different from each other.

(Schematic Configuration of Contents Utilization System)

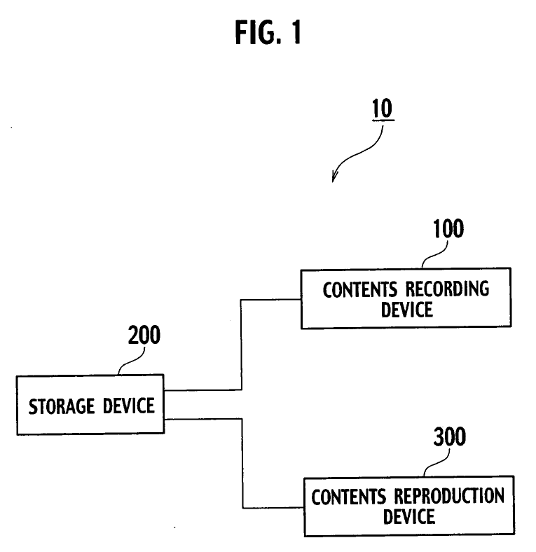

FIG. 1 shows a schematic configuration of a contents utilization system 10 according to an embodiment of the present invention. As shown in FIG. 1, the contents utilization system 10 includes a contents recording device 100, a storage device 200 and a contents reproduction device 300.

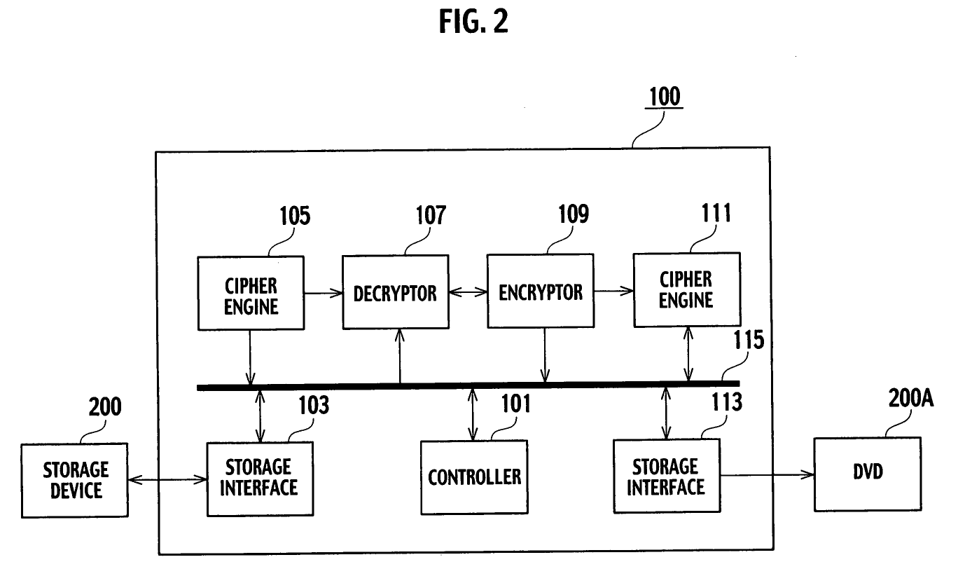

The contents recording device 100 (a contents utilization device) records digital contents, such as music data, video data and game programs, in a DVD 200A (see FIG. 2), which is different from the storage device 200, and the like. Note that, in this embodiment, description will be given below by taking the music data as an example.

The storage device 200 (a contents utilization information storage device) encrypts and stores digital contents. Moreover, the storage device 200 can manage “license data LIC” (contents utilization information) including a contents key Kcont, which is used for decrypting digital contents stored in an encrypted state, and usage rules (AC and UC), which indicate the number of times that the digital contents can be reproduced (play) by the contents reproduction device 300, the number of times that the digital contents can be copied (copy) by the contents recording device 100, and the like.

Specifically, the storage device 200 updates and stores the license data LIC including the usage rules based on output of the digital contents to the contents recording device 100 or the contents reproduction device 300.

As the storage device 200, it is possible to use a hard disk drive (HDD), a memory card (multimedia card) and the like, which can be removed from the contents recording device 100 and the contents reproduction device 300. Moreover, the storage device 200 has Tamer Resistant Module for preventing unauthorized acquisition of the license data LIC.

The contents reproduction device 300 (the contents utilization device) reads and reproduces the digital contents stored in the storage device 200.

Specifically, the contents reproduction device 300 decodes the digital contents stored in the storage device 200 by use of the contents key Kcont included in the license data LIC transmitted by the storage device 200, and reproduces the decoded digital contents.

As the contents recording device 100 and the contents reproduction device 300, it is possible to use a personal computer and a dedicated recording device (a small music player and the like) which is specialized in kinds of digital contents.

(Schematic Logic Block Configuration of Contents Utilization System)

Next, with reference to FIGS. 2 to 4, description will be given of schematic logic block configurations of the contents recording device 100, the storage device 200 and the contents reproduction device 300, which are included in the contents utilization system 10.

Note that parts related to the present invention will be mainly described below. Thus, it should be noted that the contents recording device 100, the storage device 200 and the contents reproduction device 300, which are shown in FIGS. 2 to 4, may include logical blocks (a power supply unit, a display unit and the like) which are essential for realizing functions of the devices and are not shown in the drawings or of which description is omitted.

(1) Contents Recording Device

FIG. 2 shows the schematic logic block configuration of the contents recording device 100. As shown in FIG. 2, the contents recording device 100 includes a controller 101, a storage interface 103, an cipher engine 105, a decryptor 107, an encryptor 109, an cipher engine 111, a storage interface 113 and a data bus 115.

The controller 101 controls operations of respective logical blocks included in the contents recording device 100 through the data bus 115.

Particularly, in this embodiment, the controller 101 forms a utilization determination unit which determines whether or not digital contents read from the storage device 200 are utilized, in other words, whether or not the digital contents are properly recorded in another recording medium (for example, the DVD 200A).

Moreover, if it is determined that the digital contents are not properly recorded in the other recording medium (for example, occurrence of a write error), the controller 101 requests for restoration of the license data LIC to a state before update thereof. In this embodiment, the controller 101 and the cipher engine 105 form a restoration request unit.

Specifically, the controller 101 transmits, to the storage device 200, a license ID (LID) and the usage rules AC which are encrypted by use of a temporary key (a storage device side temporary key) that is temporarily generated in the storage device 200.

Note that the license ID (LID) means an ID (a contents utilization information identifier) for identifying the license data LIC. Moreover, a more concrete method for restoring the license data LIC will be described later.

The storage interface 103 provides a connection interface with the storage device 200, and controls input and output of information to and from the storage device 200.

The cipher engine 105 executes management of the contents key Kcont, encryption of “TX information” transmitted to the storage device 200, decryption of “RX information” received from the storage device 200, and the like.

The decryptor 107 decrypts the digital contents acquired from the storage device 200, by use of the contents key Kcont.

The encryptor 109 encrypts the digital contents decrypted by the decryptor 107, by use of a cryptosystem according to standards of the DVD 200A.

The cipher engine 111 encrypts TX information transmitted to and decrypts RX information received from the DVD 200A, and the like. In this embodiment, the cipher engine 105, the decryptor 107, the encryptor 109 and the cipher engine 111 form a utilization device side cipher processor.

The storage interface 113 provides a connection interface with the DVD 200A, and controls input and output of information to and from the DVD 200A.

(2) Contents Reproduction Device

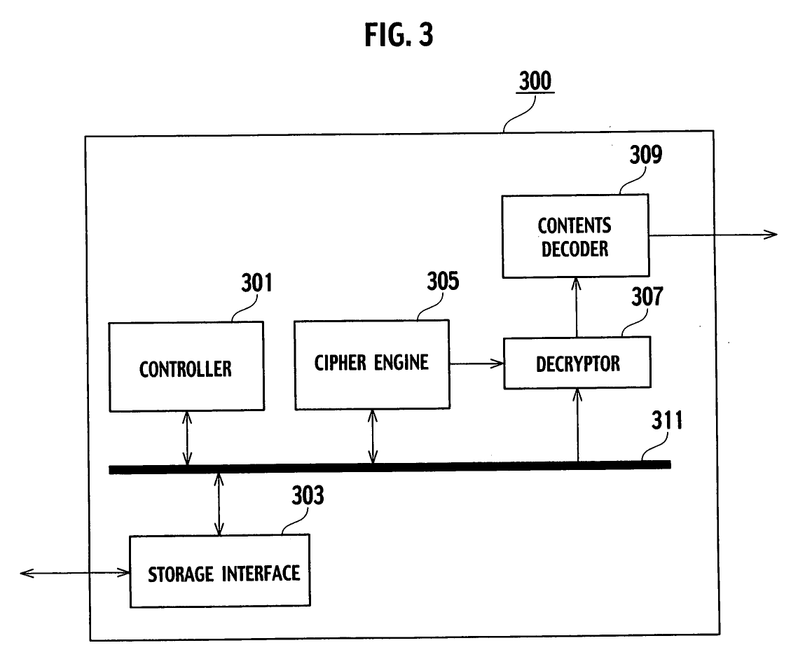

FIG. 3 shows the schematic logic block configuration of the contents reproduction device 300. As shown in FIG. 3, the contents reproduction device 300 includes a controller 301, a storage interface 303, a cipher engine 305, a decryptor 307 and a contents decoder 309.

The controller 301 controls operations of respective logical blocks included in the contents reproduction device 300 through a data bus 311.

Particularly, in this embodiment, the controller 301 forms a utilization determination unit which determines whether or not digital contents read from the storage device 200 are utilized, in other words, whether or not the digital contents can be properly reproduced.

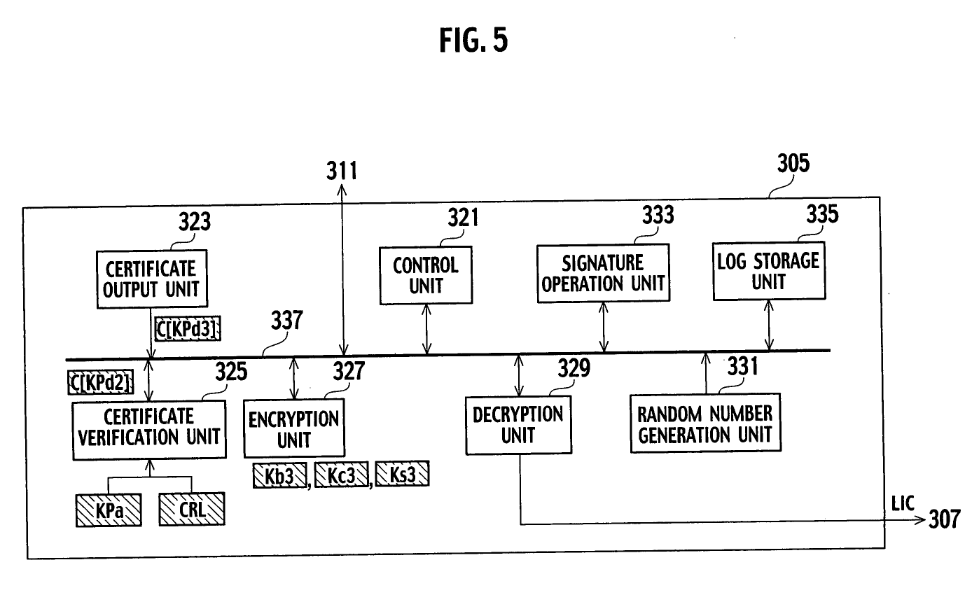

Moreover, if it is determined that the digital contents read from the storage device 200 cannot be properly reproduced, the controller 301 transmits, to the storage device 200, a license ID (LID) (a contents utilization information identifier) and usage rules AC which are stored in a log storage unit 335 (see FIG. 5). Furthermore, the controller 301 requests for restoration of license data LIC (stored contents utilization information), which is stored in the storage device 200, to a state before update thereof. In this embodiment, the controller 301 and the cipher engine 305 form a restoration request unit.

Here, “the digital contents cannot be properly reproduced” means the case where the digital contents cannot be reproduced since the contents reproduction device 300 cannot properly receive the license data LIC due to trouble with a communication path between the contents reproduction device 300 and the storage device 200.

Moreover, “the digital contents cannot be properly reproduced” includes the case where the acquired digital contents are never reproduced after the license data LIC is received from the storage device 200, and the case where only a part of the digital contents is utilized (so-called intro scan).

Specifically, the controller 301 transmits, to the storage device 200, the license ID (LID) and the usage rules AC which are encrypted by use of a temporary key (a storage device side temporary key) that is temporarily generated in the storage device 200. Note that a more concrete method for restoring the license data LIC will be described later.

The storage interface 303 provides a connection interface with the storage device 200, and controls input and output of information to and from the storage device 200.

The cipher engine 305 encrypts TX information transmitted to the storage device 200 and decrypts RX information from the storage device 200. The cipher engine 305 forms a utilization device side cipher processor.

Specifically, the cipher engine 305 shares the storage device side temporary key which is temporarily generated by the storage device 200 with the storage device 200. The cipher engine 305 encrypts object information with the storage side temporary key.

Moreover, the cipher engine 305 has the log storage unit 335 (see FIG. 5) therein to store the license ID (LID) for identifying the license data LIC and the usage rules (AC and UC) as CUI (contents utilization information) logs. Note that details of the cipher engine 305 will be described later.

The decryptor 307 decrypts the digital contents stored in the storage device 200, by use of a contents key Kcont.

The contents decoder 309 converts digital contents encoded according to a predetermined encryption rule (for example, MPEG audio layer 3 (MP3)) into analog audio signals and the like.

(3) Storage Device

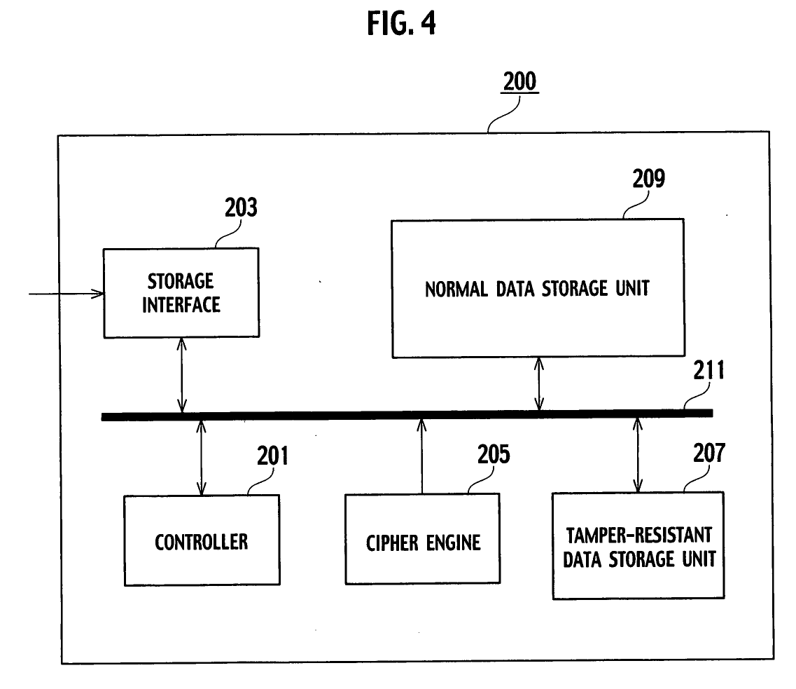

FIG. 4 shows a schematic logic block configuration of the storage device 200. As shown in FIG. 4, the storage device 200 includes a controller 201, a storage interface 203, a cipher engine 205, a tamper-resistant data storage unit 207 and a normal data storage unit 209.

The controller 201 controls operations of respective logical blocks included in the storage device 200 through a data bus 211.

Particularly, in this embodiment, the controller 201 determines whether or not to rewrite license data LIC (CUI) based on whether or not a license ID (LID) transmitted by the contents reproduction device 300 (or the contents recording device 100) coincides with a license ID (LID) (a contents utilization information identifier) which is included in license data LIC (stored contents utilization information) stored in the tamper-resistant data storage unit 207. In this embodiment, the controller 201 and the cipher engine 205 form a rewrite determination unit.

Specifically, the controller 201 determines whether or not the license ID (LID) transmitted by the contents reproduction device 300 (or the contents recording device 100) coincides with the license ID (LID) included in the license data LIC, which is updated and stored in the tamper-resistant data storage unit 207.

Furthermore, the controller 201 determines whether or not usage rules AC included in the license data LIC stored in the tamper-resistant data storage unit 207 can be rewritten, based on usage rules AC transmitted by the contents reproduction device 300 (or the contents recording device 100) together with the license ID (LID).

Moreover, the controller 201 forms a rewrite unit which rewrites the usage rules included in the license data LIC into the usage rules transmitted by the contents reproduction device 300 (or the contents recording device 100), based on a determination result obtained by the cipher engine 205 on whether or not the license data LIC can be rewritten.

Specifically, if the received license ID (LID) and usage rules AC can be decrypted by use of a temporarily generated temporary key (a storage device side temporary key), the controller 201 rewrites the usage rules AC into the usage rules AC transmitted by the contents reproduction device 300 (or the contents recording device 100).

Moreover, the controller 201 can change the license data LIC (stored contents utilization information) into a state where output is allowed together with rewrite of the usage rules AC, in either state where output of the license data LIC is allowed or prohibited before the rewrite of the usage rules AC.

The storage interface 203 provides a connection interface with the contents recording device 100 and the contents reproduction device 300, and controls input and output of information to and from the devices.

The cipher engine 205 encrypts TX information transmitted to and decrypts RX information received from the contents recording device 100 and the contents reproduction device 300. The cipher engine 205 forms a storage device side cipher processor.

Specifically, the cipher engine 205 temporarily generates a storage device side temporary key, shares the generated storage side device temporary key with the contents recording device 100 and the contents reproduction device 300, and decrypts object information encrypted with the storage device side temporary key.

The tamper-resistant data storage unit 207 is formed of Tamper Resistant Module. The tamper-resistant data storage unit 207 stores a connection log including the license data LIC, the temporary key and the like.

Note that Tamper Resistant Module is realized by software (which, for example, transmits and receives information by utilizing an encrypted communication path) and hardware (which, for example, has a structure in which an internal circuit is completely destroyed when a surface of Tamper Resistant Module is peeled off).

The normal data storage unit 209 stores encrypted digital contents and the like. Unlike the tamper-resistant data storage unit 207, tamper resistance is not ensured in the normal data storage unit 209.

(Logic Block Configuration of Cipher Engine)

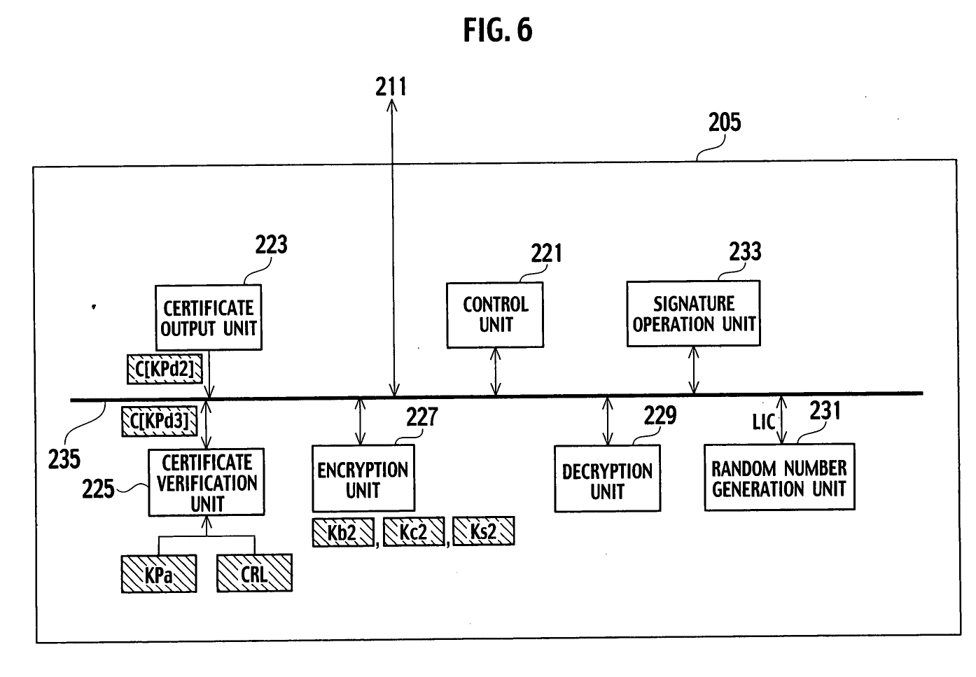

Next, with reference to FIGS. 5 and 6, description will be given of logic block configurations of the cipher engines (the cipher engines 305 and 205) which execute processing related to a main part of the present invention. Note that the cipher engine 105 included in the contents recording device 100 has approximately the same configuration and functions as those of the cipher engine 305 included in the contents reproduction device 300. Thus, description will be given below by taking the cipher engine 305 as an example.

(1) Method for Expressing Key, Encrypted Information and Certificate

First, description will be given of a method for expressing keys used by the cipher engines 305 and 205, encrypted information (E) encrypted by use of the keys, and certificates.

(1.1) Key Based on Public Key Cryptosystem

Keys based on a main public key cryptosystem used by the cipher engines 305 and 205 are expressed as below.
KPp3: a public key of the cipher engine 305
KPd3: a public key of the cipher engine 305
Kp3: a private key of the cipher engine 305, which is paired with the public key KPp3
Kd3: a private key of the cipher engine 305, which is paired with the public key KPd3
KPp2: a public key of the cipher engine 205
KPd2: a public key of the cipher engine 205
Kp2: a private key of the cipher engine 205, which is paired with the public key KPp2
Kd2: a private key of the cipher engine 205, which is paired with the public key KPd2
KPa: a root public key issued by a certification authority
   (1.2) Key Based on Symmetric Key Cryptosystem

Keys (temporary keys) based on a main symmetric key (common key) cryptosystem used by the cipher engines 305 and 205 are expressed as below.
Kb3, Kc3, Ks3: symmetric keys generated by the cipher engine 305
Kb2, Kc2, Ks2: symmetric keys generated by the cipher engine 205
   (1.3) Encrypted Information (E)

The encrypted information (E) encrypted by use of the keys described above is expressed in a form of “E (K, D)”. “E (K, D)” means the encrypted information (E) obtained by encrypting information D by use of keys K. Moreover, “A∥B” means information obtained by connecting information A to information B.

(1.4) Certificate

Certificates of the keys described above are expressed as below.
C[KPd3]: a certificate of the contents reproduction device 300 (the public key KPd3)
C[KPd2]: a certificate of the storage device 200 (the public key KPd2).
   (2) Configuration of License Data LIC

Next, a configuration of license data LIC will be described. The license data LIC has the following configuration.
License data LIC: licensed information LC+contents key Kcont

Moreover, the licensed information LC has the following configuration.
Licensed information LC: license ID (LID)+usage rules (AC and UC)

The license ID (LID) is a contents utilization information identifier for identifying the license data LIC.

The usage rule AC (Access Condition) defines utilization requirements forced by the storage device 200 and limits the number of times that digital contents are reproduced, the number of times that the digital contents are copied, a protection level (for example, a licensing period for utilization of the digital contents) and the like.

The usage rule UC (Utilization condition) defines utilization requirements forced when the digital contents are decrypted (for example, prohibits editing of the digital contents).

(3) Cipher Engine 305

FIG. 5 shows the logic block configuration of the cipher engine 305 included in the contents reproduction device 300. As shown in FIG. 5, the cipher engine 305 includes a control unit 321, a certificate output unit 323, a certificate verification unit 325, an encryption unit 327, a decryption unit 329, a random number generation unit 331, a signature operation unit 333, a log storage unit 335 and a local bus 337.

The control unit 321 controls respective logical blocks included in the cipher engine 305 through the local bus 337 according to contents of control by the controller 301.

The certificate output unit 323 outputs the certificate C[KPd3] of the contents reproduction device 300 (the public key KPd3). The certificate C[KPd3] is formed of the public key KPd3 encrypted (signed) by use of a private key (Ka) of a certification authority.

The certificate verification unit 325 verifies the certificate C[KPd2] of the storage device 200 (the public key KPd2). The certificate verification unit 325 verifies the certificate C[KPd2] by use of the root public key KPa of the certification authority.

Moreover, the certificate verification unit 325 excludes invalid certificates from those to be verified, by use of a certificate revocation list (CRL) that is a list of the invalid certificates.

The encryption unit 327 uses the public key cryptosystem and the symmetric key (common key) cryptosystem to encrypt information outputted to the outside of the cipher engine 305. In this embodiment, the encryption unit 327 uses an elliptic curve cryptosystem as the public key cryptosystem, and uses Triple-DES as the common key cryptosystem. As a matter of course, the encryption unit 327 may use other cryptosystem (for example, a RSA public key cryptosystem).

The decryption unit 329 uses the public key cryptosystem and the common key cryptosystem to decrypt information inputted to the cipher engine 305. The decryption unit 329 uses the same cryptosystems as those used by the encryption unit 327. Moreover, the decryption unit 329 outputs the decrypted license data LIC to the decryptor 307.

The random number generation unit 331 generates random numbers used for generating temporary keys (the symmetric keys Kb3, Kc3 and Ks3) which are temporarily generated for encryption.

The signature operation unit 333 performs operation of electronic signature data added to the information outputted to the outside of the cipher engine 305. Specifically, the signature operation unit 333 performs the operation of the electronic signature data by use of a predetermined hash function (for example, SHA-1) and the like.

The log storage unit 335, as described above, stores a connection log including a transfer log list (a CUI log), temporary keys and the like. Specifically, the transfer log list includes the license ID (LID) for identifying the license data LIC received from the storage device 200, the usage rules AC and UC, and address information ADR indicating storage destinations of the license data LIC in the storage device 200.

(4) Cipher Engine 205

FIG. 6 shows the logic block configuration of the cipher engine 205 included in the storage device 200. As shown in FIG. 6, the cipher engine 205 includes a control unit 221, a certificate output unit 223, a certificate verification unit 225, an encryption unit 227, a decryption unit 229, a random number generation unit 231, a signature operation unit 233 and a local bus 235.

The control unit 221 controls respective logical blocks included in the cipher engine 205 through the local bus 235 according to contents of control by the controller 201.

The certificate output unit 223 outputs the certificate C[KPd2] of the storage device 200 (the public key KPd2). The certificate C[KPd2] is formed of the public key KPd2 encrypted (signed) by use of a private key (Ka) of a certification authority.

The certificate verification unit 225 verifies the certificate C[KPd3] of the contents reproduction device 300 (the public key KPd3). The certificate verification unit 225 verifies the certificate C[KPd3] by use of the root public key KPa of the certification authority.

Moreover, the certificate verification unit 225 excludes invalid certificates from those to be verified, by use of a certificate revocation list (CRL) that is a list of the invalid certificates.

The encryption unit 227 and the decryption unit 229 have approximately the same functions as those of the encryption unit 327 and the decryption unit 329 (see FIG. 5) described above. The encryption unit 227 and the decryption unit 229 use the public key cryptosystem and the common key cryptosystem to encrypt information outputted from the cipher engine 205 and to decrypt information inputted to the cipher engine 205.

The random number generation unit 231 generates random numbers used for generating temporary keys (the symmetric keys Kb2, Kc2 and Ks2) which are temporarily generated for encryption.

The signature operation unit 233 performs operation of electronic signature data added to information outputted to the outside of the cipher engine 205.

(Restoring Operation of License Data by Contents Utilization System)

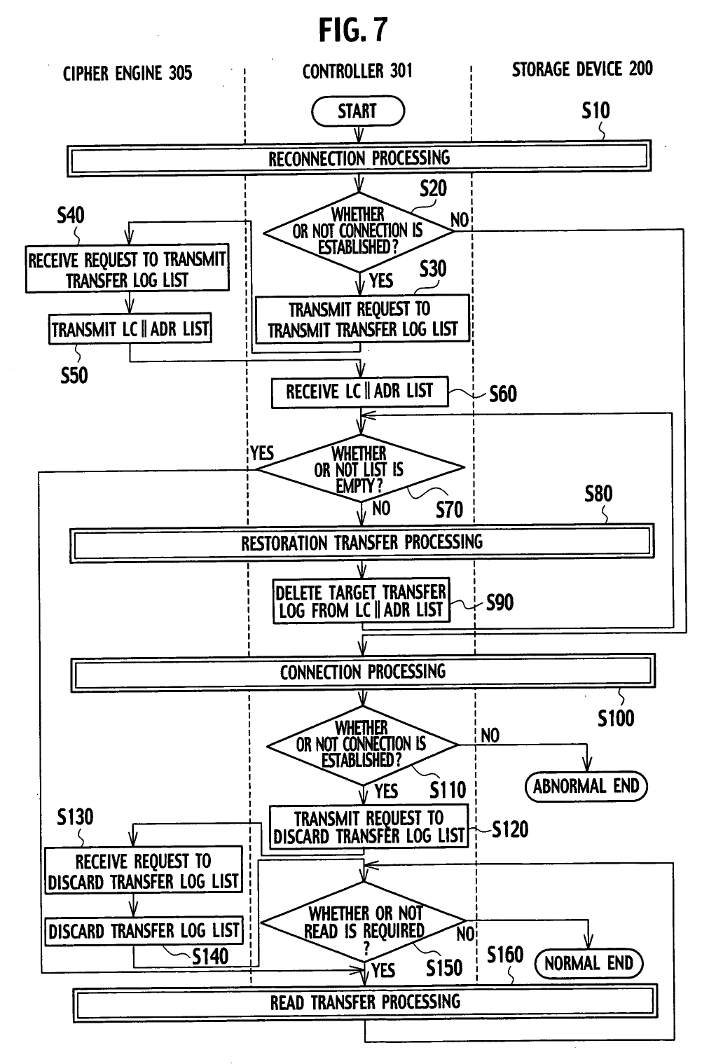

Next, with reference to FIGS. 7 to 14, description will be given of a restoring operation of the license data LIC by the above-described contents utilization system 10 (the storage device 200 and the contents reproduction device 300).

(1) Overall Operation

FIG. 7 shows an overall operation flow including the restoring operation of the license data LIC by the contents utilization system 10.

As shown in FIG. 7, in Step S10, if it is required to establish a communication connection again between the storage device 200 and the contents reproduction device 300, the storage device 200 and the contents reproduction device 300 (the controller 301 and the cipher engine 305) execute “reconnection processing”. Note that details of the reconnection processing will be described later.

In Step S20, the controller 301 determines whether or not the communication connection to the storage device 200 is established.

If the communication connection to the storage device 200 is established (YES in Step S20), in Step S30, the controller 301 transmits a request to transmit a transfer log list (a CUI log) to the cipher engine 305.

If the communication connection to the storage device 200 is not established (NO in Step S20), the controller 301 executes processing of Step S100.

In Step S40, the cipher engine 305 receives the request to transmit the transfer log list from the controller 301.

In Step S50, based on the transfer log list, the cipher engine 305 transmits, to the controller 301, a list of “LC ∥ADR” which is obtained by connecting licensed information LC to address information ADR.

Here, in the “transfer log list”, the following CUI logs are stored. Specifically, as the transfer log list, CUI logs in the following cases are stored, including: the case where a communication path between the storage device 200 and the contents reproduction device 300 is interrupted during transmission of the license data LIC to the contents reproduction device 300 from the storage device 200, and the contents reproduction device 300 cannot properly receive the license data LIC; and the case where, even though the contents reproduction device 300 properly receives the license data LIC, processing is not completed due to an accident such as cutting off a power source of the contents reproduction device 300 before decryption by use of a contents key Kcont, in other words, before it is judged that digital contents are utilized.

The list of LC∥ADR is transmitted based on the transfer log list. Accordingly, if the list of LC∥ADR is empty, it means that all processing for the license data LIC transmitted through the previously set communication connection is completed.

Meanwhile, if the list of LC∥ADR is not empty, that is, if the list of LC∥ADR includes some kind of information, it means that it may be required to restore the license data LIC.

In Step S60, the controller 301 receives the list of LC∥ADR from the cipher engine 305.

In Step S70, the controller 301 determines whether or not the received list of LC∥ADR is empty, that is, whether or not the list of LC∥ADR includes information.

If the list of LC∥ADR is empty (YES in Step S70), the controller 301 determines that restoration of the license data LIC is not required and executes processing (read transfer processing) of Step S160.

If the list of LC∥ADR is not empty (NO in Step S70), in Step S80, the storage device 200 and the contents reproduction device 300 execute “restoration transfer processing” of restoring contents of the license data LIC to a state before update of the license data LIC, which is involved in utilization of digital contents. Note that details of the restoration transfer processing will be described later.

In Step S90, based on completion of the restoration transfer processing in Step S80, the controller 301 deletes the transfer log list (the CUI log) being restored from the list of LC∥ADR.

In Step S100, the storage device 200 and the contents reproduction device 300 execute “connection processing” of establishing a communication connection between the storage device 200 and the contents reproduction device 300. Note that details of the connection processing will be described later.

In Step S110, the controller 301 determines whether or not the communication connection to the storage device 200 is established.

If the communication connection to the storage device 200 is not established (NO in Step S110), the controller 301 determines that the communication connection to the storage device 200 cannot be established and finishes the processing as an abnormal end.

If the communication connection to the storage device 200 is established (YES in Step S110), in Step S120, the controller 301 transmits a request to discard the transfer log list to the cipher engine 305.

Specifically, if the connection processing is executed in Step S100, it is determined that the transfer log list recorded in the past for restoring the license data LIC is no longer required. Thus, the controller 301 transmits the request to discard the transfer log list to the cipher engine 305.

In Step S130, the cipher engine 305 receives the request to discard the transfer log list. In Step S140, based on the received request to discard the transfer log list, the cipher engine 305 discards the transfer log list stored in the log storage unit 335.

In Step S150, the controller 301 determines whether or not to execute a read request, specifically, whether to read the license data LIC for utilizing the digital contents or to finish the processing.

Here, “to read the license data LIC” means to start read of the license data LIC corresponding to digital contents of which reproduction is instructed by a user of the contents reproduction device 300.

Moreover, “to finish the processing” means to cut off the power source of the contents reproduction device 300 through normal processing, to stop a power supply to the storage device 200 for shifting to a low power consumption state aimed at power saving, or the like.

Specifically, in Step S150, the controller 301 is in a state of waiting for an instruction to start the next processing.

If the read request is executed (YES in Step S150), in Step S160, the storage device 200 and the contents reproduction device 300 execute “read transfer processing” of reading encrypted digital contents from the storage device 200 and reproducing the digital contents.

Moreover, once the read transfer processing is finished, the storage device 200 and the contents reproduction device 300 return to the processing of Step S150 and prepare for transfer of next license data LIC and the like.

(2) Connection Processing

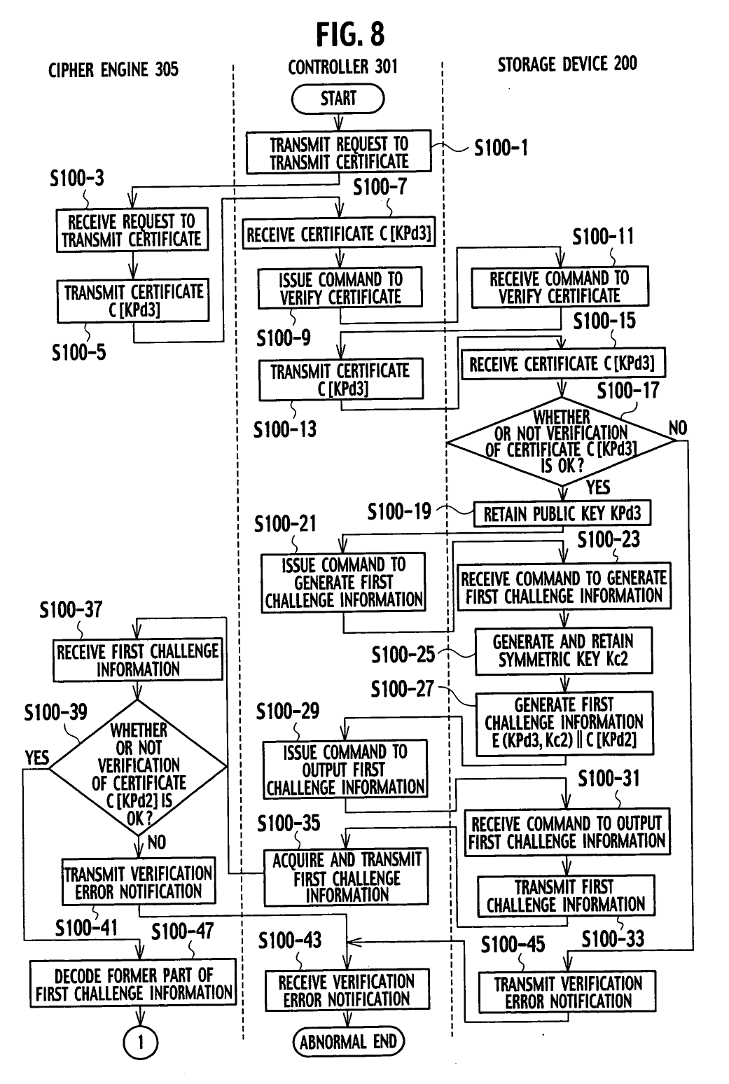

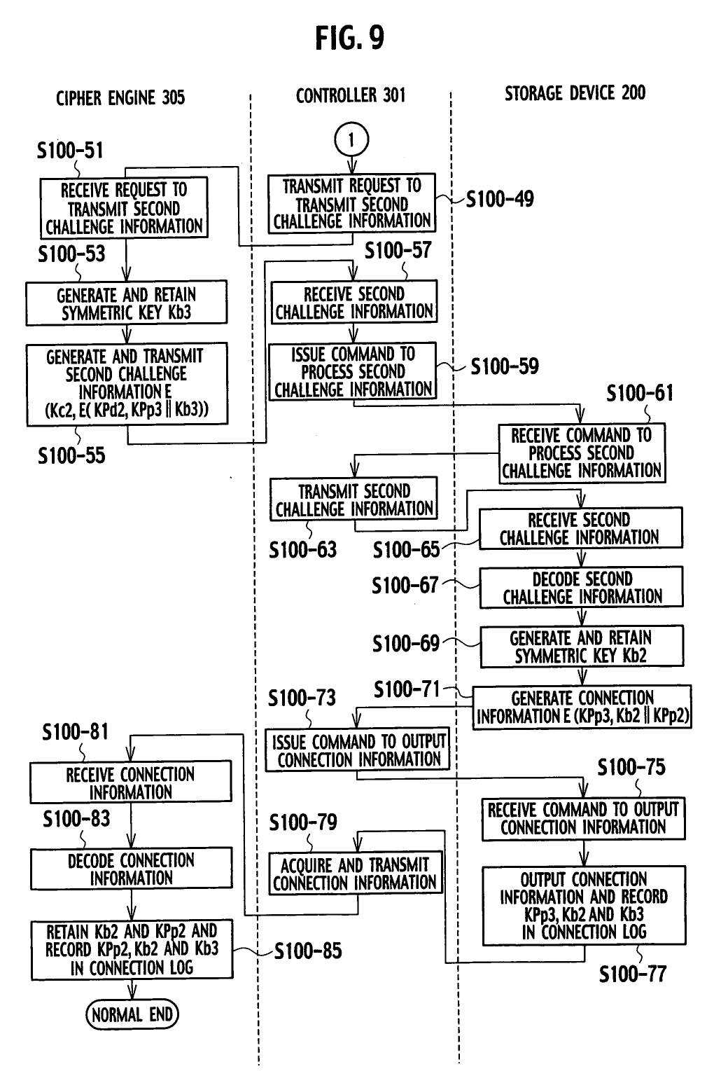

FIGS. 8 and 9 show contents of the connection processing in Step S100 described above. As shown in FIG. 8, in Step S100-1, the controller 301 transmits a request to transmit a certificate to the cipher engine 305. In Step S100-3, the cipher engine 305 receives the request to transmit the certificate from the controller 301.

In Step S100-5, the cipher engine 305 transmits a certificate C[KPd3] of the contents reproduction device 300 to the controller 301. In Step S100-7, the controller 301 receives the certificate C[KPd3] from the cipher engine 305.

In Step S100-9, the controller 301 transmits a command to verify the certificate C[KPd3] to the storage device 200. In Step S100-11, the storage device 200 receives the command to verify the certificate C[KPd3] from the controller 301.

In Step S100-13, the controller 301 transmits the certificate C[KPd3] received from the cipher engine 305 to the storage device 200. In Step S100-15, the storage device 200 receives the certificate C[KPd3] from the controller 301.

In Step S100-17, the storage device 200 determines whether or not the certificate C[KPd3] is valid by verifying the certificate C[KPd3].

If the certificate C[KPd3] is valid (YES in Step S100-17), in Step S100-19, the storage device 200 retains a public key KPd3 included in the certificate C[KPd3].

If the certificate C[KPd3] is not valid (NO in Step S100-17), in Step S100-45, the storage device 200 transmits, to the controller 301, a verification error notification indicating that the certificate C[KPd3] cannot be verified.

In Step S100-21, the controller 301 issues a command to generate first challenge information to the storage device 200. In Step S100-23, the storage device 200 receives the command to generate the first challenge information from the controller 301.

In Step S100-25, the storage device 200 generates and retains a symmetric key Kc2 based on the command to generate the first challenge information.

In Step S100-27, the storage device 200 uses the generated symmetric key Kc2 to generate the first challenge information E(KPd3, Kc2)∥C[KPd2].

In Step S100-29, the controller 301 issues a command to output the first challenge information to the storage device 200. In Step S100-31, the storage device 200 receives the command to output the first challenge information from the controller 301.

In Step S100-33, the storage device 200 transmits the first challenge information E(KPd3, Kc2)∥C[KPd2] to the controller 301. In Step S100-35, the controller 301 acquires the first challenge information E(KPd3, Kc2)∥C[KPd2] transmitted by the storage device 200 and transmits the acquired first challenge information to the cipher engine 305.

In Step S100-37, the cipher engine 305 receives the first challenge information E(KPd3, Kc2)∥C[KPd2].

In Step S100-39, the cipher engine 305 verifies a certificate C[KPd2] included in the first challenge information E(KPd3, Kc2)∥C[KPd2], and determines whether or not the certificate C[KPd2] is valid.

If the certificate C[KPd2] is not valid (NO in Step S100-39), in Step S100-41, the cipher engine 305 transmits a verification error notification to the controller 301. In Step S100-43, the controller 301 receives the verification error notification from the cipher engine 305 or the storage device 200 and finishes the connection processing as an abnormal end.

If the certificate C[KPd2] is valid (YES in Step S100-39), in Step S100-47, the cipher engine 305 decrypts the former part E(KPd3, Kc2) of the first challenge information E(KPd3, Kc2) ∥C[KPd2].

Next, as shown in FIG. 9, in Step S100-49, the controller 301 transmits a request to transmit second challenge information to the cipher engine 305. In Step S100-51, the cipher engine 305 receives the request to transmit the second challenge information from the controller 301.

In Step S100-53, the cipher engine 305 generates and retains a symmetric key Kb3 based on a command to generate the second challenge information.

In Step S100-55, the cipher engine 305 uses the generated symmetric key Kb3 to generate the second challenge information E(Kc2, E(KPd2, KPp3∥Kb3)), and transmits the generated second challenge information E(Kc2, E(KPd2, KPp3∥Kb3)) to the controller 301.

In Step S100-57, the controller 301 receives the second challenge information E(Kc2, E(KPd2, KPp3∥Kb3)) from the cipher engine 305.

In Step S100-59, the controller 301 issues a command to process the second challenge information to the storage device 200. In Step S100-61, the storage device 200 receives the command to process the second challenge information from the controller 301.

In Step S100-63, the controller 301 transmits the second challenge information E (Kc2, E(KPd2, KPp3∥Kb3)) to the storage device 200. In Step S100-65, the storage device 200 receives the second challenge information E(Kc2, E(KPd2, KPp3∥Kb3)) from the controller 301.

In Step S100-67, the storage device 200 decrypts the second challenge information E(Kc2, E(KPd2, KPp3∥Kb3)).

In Step S100-69, the storage device 200 generates and retains a symmetric key Kb2. In Step S100-71, the storage device 200 uses the symmetric key Kb2 to generate connection information E(KPp3, Kb2∥KPp2).

In Step S100-73, the controller 301 issues a command to output the connection information to the storage device 200. In Step S100-75, the storage device 200 receives the command to output the connection information from the controller 301.

In Step S100-77, the storage device 200 outputs the connection information E(KPp3, Kb2∥KPp2). Furthermore, the storage device 200 records KPp3, Kb2 and Kb3 in a “connection log”.

Note that the connection log is used for reconnection processing. Moreover, each of the symmetric keys Kb2 and Kb3, which are shared in a latest communication connection (including a communication connection by the reconnection processing), and a public key KPp3 of a destination of the communication connection is stored.

In Step S100-79, the controller 301 acquires the connection information E(Kb3, E(KPp3, Kb2∥KPp2)) transmitted by the storage device 200, and transmits the acquired connection information to the cipher engine 305.

In Step S100-81, the cipher engine 305 receives the connection information E(Kb3, E(KPp3, Kb2∥KPp2)) from the controller 301. In Step S100-83, the cipher engine 305 decrypts the connection information E(Kb3, E(KPp3, Kb2∥KPp2)) to take out the symmetric key Kb2 and a public key KPp2.

In Step S100-85, the cipher engine 305 retains the symmetric key Kb2 and the public key KPp2 which are taken out of the connection information E(Kb3, E(KPp3, Kb2∥KPp2)), records KPp2, Kb2 and Kb3 in a “connection log”, and finishes the connection processing.

Specifically, by executing the processing up to Step S100-85, the public keys KPp2 and KPp3 of the storage device 200 (the cipher engine 205) and the cipher engine 305 are exchanged. Moreover, Kb2 and Kb3 are temporarily shared in the storage device 200 and the contents reproduction device 300, and the communication connection is established. Thus, by use of the established communication connection, encrypted communication is performed.

Note that the connection log is used for the reconnection processing. Moreover, each of the symmetric keys Kb2 and Kb3, which are shared in the latest communication connection (including the communication connection by the reconnection processing), and the public key KPp2 of a destination of the communication connection is stored.

(3) Reconnection Processing

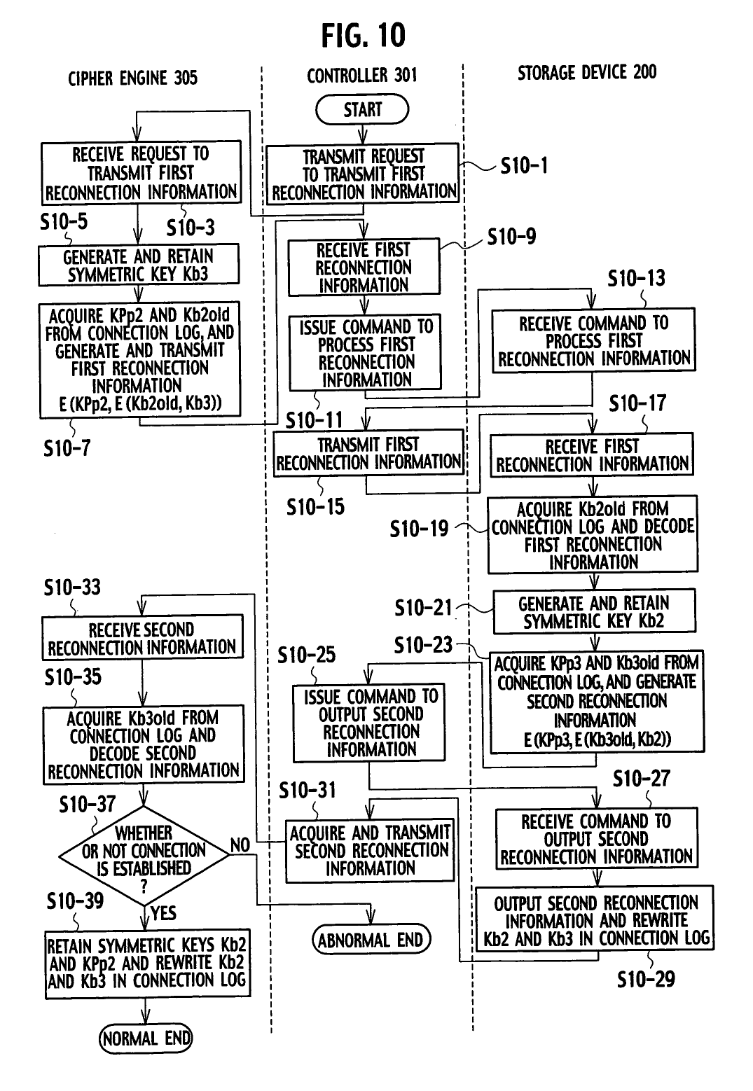

FIG. 10 shows contents of the reconnection processing in Step S10 described above. As shown in FIG. 10, in Step S10-1, the controller 301 transmits, to the cipher engine 305, a request to transmit first reconnection information required to establish a communication connection again between the storage device 200 and the contents reproduction device 300. In Step S10-3, the cipher engine 305 receives the request to transmit the first reconnection information from the controller 301.

In Step S10-5, the cipher engine 305 generates and retains a symmetric key Kb3 based on the request to transmit the first reconnection information.

In Step S10-7, the cipher engine 305 acquires a public key KPp2 and a symmetric key Kb2old from a connection log. Note that symmetric keys Kb2old and Kb3old mean symmetric keys Kb2 and Kb3 recorded in the connection log at the time of the processing of Step S10-7.

The cipher engine 305 generates the first reconnection information E(KPp2, E(Kb2old, Kb3)) by acquiring the public key KPp2 and the symmetric key Kb2old, and transmits the generated first reconnection information to the controller 301.

In Step S10-9, the controller 301 receives the first reconnection information E(KPp2, E(Kb2old, Kb3)) from the cipher engine 305.

In Step S10-11, the controller 301 issues a command to process the first reconnection information to the storage device 200. In Step S10-13, the storage device 200 receives the command to process the first reconnection information from the controller 301.

In Step S10-15, the controller 301 transmits the first reconnection information E(KPp2, E(Kb2old, Kb3)) to the storage device 200. In Step S10-17, the storage device 200 receives the first reconnection information E(KPp2, E(Kb2old, Kb3)) from the controller 301.

In Step S10-19, the storage device 200 decrypts the first reconnection information by acquiring the symmetric key Kb2old from the connection log, and takes out the symmetric key Kb3.

In Step S10-21, the storage device 200 generates and retains the symmetric key Kb2. In Step S10-23, the storage device 200 acquires the public key KPp3 and the symmetric key Kb3old from the connection log, and generates second reconnection information E(KPp3, E(Kb3old, Kb2)).

In Step S10-25, the controller 301 issues a command to output the second reconnection information to the storage device 200. In Step S10-27, the storage device 200 receives the command to output the second reconnection information from the controller 301.

In Step S10-29, the storage device 200 outputs the second reconnection information E(KPp3, E(Kb3old, Kb2)). Furthermore, the storage device 200 rewrites the symmetric keys Kb2old and Kb3old, which are recorded in the connection log, into Kb2 and Kb3.

In Step S10-31, the controller 301 acquires the second reconnection information E(KPp3, E(Kb3old, Kb2)) transmitted by the storage device 200, and transmits the acquired second reconnection information to the cipher engine 305.

In Step S10-33, the cipher engine 305 receives the second reconnection information E(KPp3, E(Kb3old, Kb2)) from the controller 301.

In Step S10-35, the cipher engine 305 decrypts the second reconnection information by acquiring the symmetric key Kb3old from the connection log, and takes out the symmetric key Kb2.

In Step S10-37, the cipher engine 305 determines whether or not the communication connection is established between the storage device 200 and the contents reproduction device 300, in other words, whether or not the symmetric keys Kb2 and Kb3 are shared between the storage device 200 (the cipher engine 205) and the cipher engine 305.

If the communication connection to the storage device 200 is established (YES in Step S10-37), in Step S10-39, the cipher engine 305 retains the symmetric keys Kb2 and KPp2, rewrites the symmetric keys Kb2old and Kb3old, which are recorded in the connection log, into Kb2 and Kb3, and finishes the reconnection processing.

If the communication connection to the storage device 200 is not established (NO in Step S10-37), the controller 301 and the cipher engine 305 determine that the communication connection to the storage device 200 cannot be established, and finish the reconnection processing as an abnormal end.

Note that whether or not the communication connection is established can be determined, for example, by whether or not a data structure of decrypted digital contents has a predetermined form.

Moreover, the processing may be continued by assuming that the communication connection is always established without determining whether or not the communication connection is established in Step S10-37.

In this case, if the communication connection is established, the subsequent encrypted data is properly transferred. If the communication connection is not established, the encrypted data cannot be decrypted even if the data is transferred.

(4) Read Transfer Processing

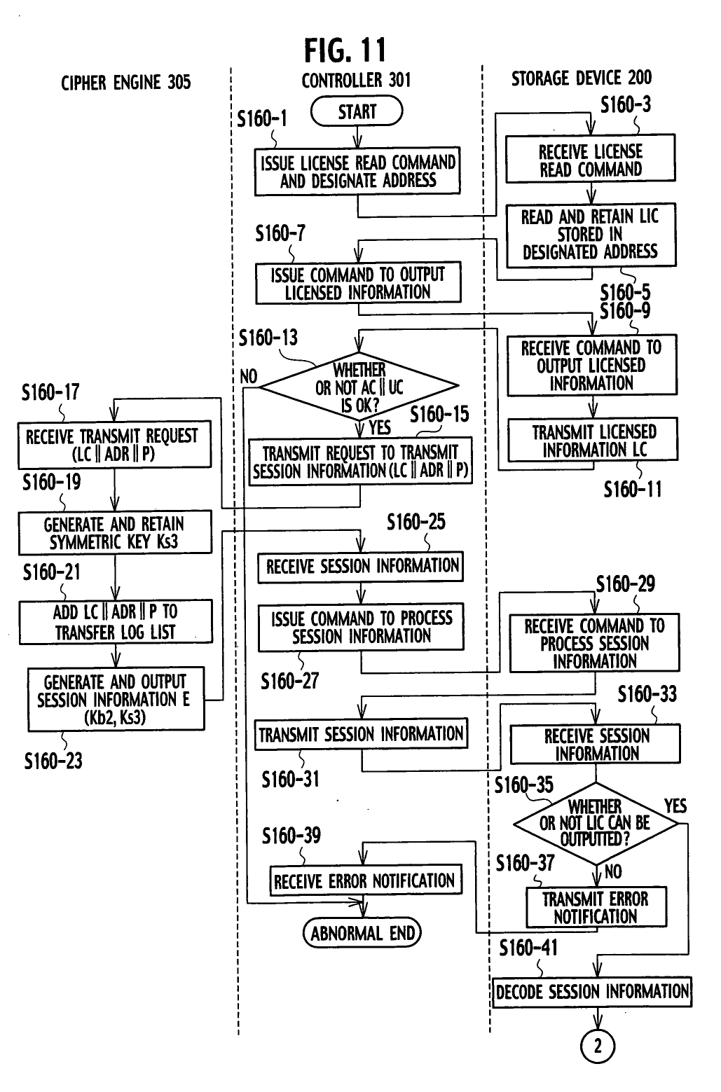

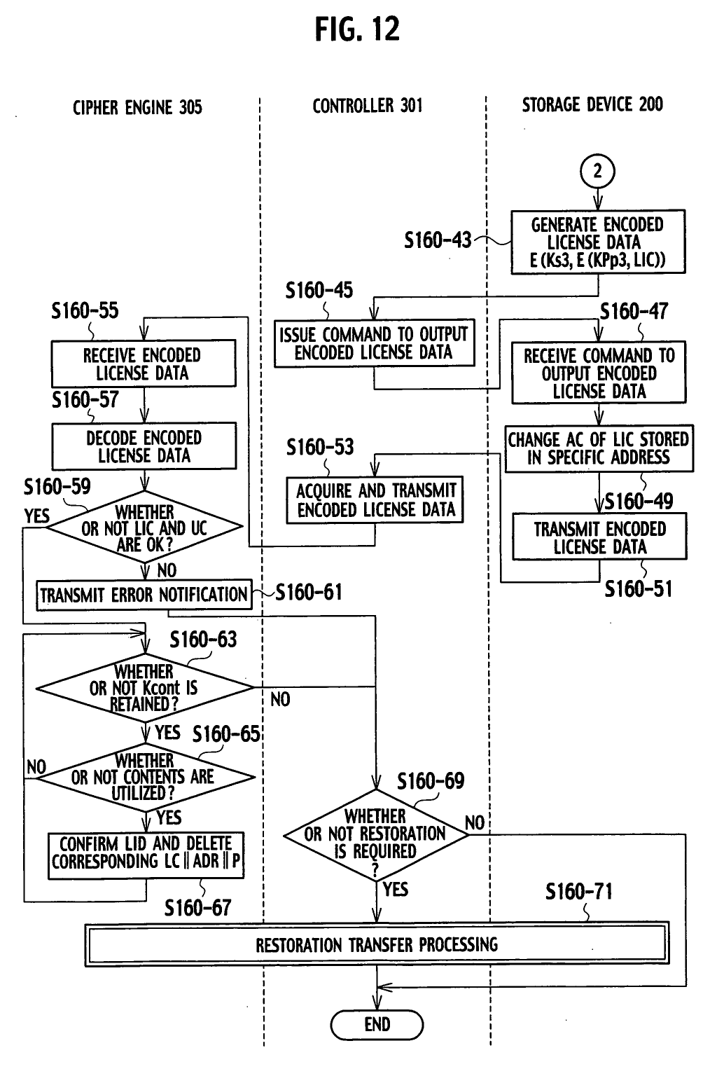

FIGS. 11 and 12 show contents of the read transfer processing in Step S160 described above. As shown in FIG. 11, in Step S160-1, the controller 301 refers to the transfer log list and issues to the storage device 200 a license read command to read the license data LIC stored in the storage device 200 (the tamper-resistant data storage unit 207). Moreover, the controller 301 designates an address of the tamper-resistant data storage unit 207 in which the license data LIC is stored.

In Step S160-3, the storage device 200 receives the license read command from the controller 301. In Step S160-5, the storage device 200 reads and retains the license data LIC stored in the designated address.

In Step S160-7, the controller 301 issues a command to output the licensed information LC to the storage device 200. In Step S160-9, the storage device 200 receives the command to output the licensed information LC from the controller 301.

In Step S160-11, the storage device 200 transmits the licensed information LC included in the license data LIC to the controller 301.

In Step S160-13, the controller 301 determines whether or not contents of “AC∥UC” obtained by connecting the usage rules AC and UC included in the licensed information LC received from the storage device 200 are OK, in other words, whether or not corresponding digital contents can be utilized (for example, reproduced).

If the digital contents can be utilized (YES in Step S160-13), in Step S160-15, the controller 301 transmits a request to transmit session information (LC∥ADR∥P) to the cipher engine 305. Note that processing information “P” indicates utilization types (playback, copy and move) of the digital contents.

If the digital contents cannot be utilized (NO in Step S160-13), the controller 301 finishes the read transfer processing as an abnormal end.

In Step S160-17, the cipher engine 305 receives the request to transmit the session information from the controller 301.

In Step S160-19, the cipher engine 305 generates and retains a symmetric key Ks3 based on the request to transmit the session information.

In Step S160-21, the cipher engine 305 adds the received request to transmit the session information (LC∥ADR∥P) to the transfer log list. Note that the processing information P may not be included in the request. The contents of the processing information P can be checked by use of changes in the contents of the usage rule AC included in the license data LIC stored in the storage device 200.

In Step S160-23, the cipher engine 305 generates session information E(Kb2, Ks3) and transmits the generated session information to the controller 301. In Step S160-25, the controller 301 receives the session information from the cipher engine 305.

In Step S160-27, the controller 301 issues a command to process the session information to the storage device 200. In this event, the controller 301 also designates the utilization type.

In Step S160-29, the storage device 200 receives the command to process the session information from the controller 301.

In Step S160-31, the controller 301 transmits the session information E(Kb2, Ks3) to the storage device 200. In Step S160-33, the storage device 200 receives the session information from the controller 301.

In Step S160-35, the storage device 200 determines whether or not the license data LIC can be outputted, based on the utilization type designated by the command to process the session information and the usage rule AC included in the license data LIC.

The utilization type applied to the contents reproduction device 300 is only playback. Hence, the storage device 200 determines that the license data LIC cannot be outputted in the following cases, including: 1) the case where a reproduction frequency of digital contents is set in the usage rule AC, and a value of the reproduction frequency is “0” (in other words, there is no more reproduction to be performed); 2) the case where the license data LIC is previously subjected to move and cannot be outputted; 3) the case where requirements of an output destination are described in the usage rule AC, and the contents reproduction device 300 does not meet the requirements; and the like.

Note that the reason the state where the license data LIC cannot be outputted is set for move is because the license data LIC cannot be restored if the license data LIC is deleted by move. Moreover, in this embodiment, by reflecting the state where the license data LIC cannot be outputted due to move on the usage rule AC, it is possible to determine whether or not the license data LIC can be outputted based on the usage rule AC.

However, it is not necessarily required to reflect the state where the license data LIC cannot be outputted due to move on the usage rule AC. Whether or not the license data LIC can be outputted may be determined separately by use of new “state information”. In this case, in Step S160-35, the storage device 200 determines whether or not the license data LIC can be outputted by referring also to the state information.

Moreover, in the case where the contents recording device 100 is used instead of the contents reproduction device 300, the utilization type is set to copy or move. In the case of copy, determination by “copy prohibition/copy frequency” is added instead of the reproduction frequency. In the case of move, determination by “move prohibition” is added instead of the reproduction frequency.

If the license data LIC cannot be outputted (NO in Step S160-35), in Step S160-37, the storage device 200 transmits, to the controller 301, an error notification indicating that the license data LIC cannot be outputted. In Step S160-39, the controller 301 receives the error notification from the storage device 200, and finishes the read transfer processing as an abnormal end.

If the license data LIC can be outputted (YES in Step S160-35), in Step S160-41, the storage device 200 decrypts the received session information E(Kb2, Ks3).

Next, as shown in FIG. 12, in Step S160-43, the storage device 200 generates E(Ks3, E(KPp3, LIC)) that is encrypted license data LIC.

In Step S160-45, the controller 301 issues a command to output the encrypted license data to the storage device 200. In Step S160-47, the storage device 200 receives the command to output the encrypted license data from the controller 301.

In Step S160-49, the storage device 200 changes the contents of the usage rule AC included in the license data LIC stored in a specific address in the tamper-resistant data storage unit 207. For example, in the usage rule AC, if the reproduction frequency of the digital contents is specified to 100 times, the frequency is reduced to 99 times.

Note that, in the case of copy, if the copy frequency is specified, the frequency is reduced by “1”. In the case of move, the license data LIC is set in a state where the data can no longer be outputted.

In Step S160-51, the storage device 200 transmits the generated encrypted license data E(Ks3, E(KPp3, LIC)) to the controller 301. In Step S160-53, the controller 301 acquires the encrypted license data E(Ks3, E(KPp3, LIC)) transmitted by the storage device 200, and transmits the acquired encrypted license data to the cipher engine 305.

In Step S160-55, the cipher engine 305 receives the encrypted license data E(Ks3, E(KPp3, LIC)) from the controller 301.

In Step S160-57, the cipher engine 305 decrypts the encrypted license data E(Ks3, E(KPp3, LIC)).

In Step S160-59, the cipher engine 305 determines whether or not the decrypted license data LIC coincides with a license ID (LID) included in the stored transfer log list. Furthermore, the cipher engine 305 confirms reproduction requirements by checking the usage rule UC included in the license data LIC with which the license ID (LID) coincides.

If the license ID (LID) does not coincide or if the reproduction requirements are not fulfilled (NO in Step S160-59), in Step S160-61, the cipher engine 305 transmits, to the controller 301, an error notification indicating that reproduction cannot be performed.

If the license ID (LID) coincides and the reproduction requirements are fulfilled (YES in Step S160-59), in Step S160-63, the cipher engine 305 determines that a contents key Kcont, which is included in the license data LIC, to be supplied to the decryptor 307 is retained, or utilization of the contents key Kcont is finished. Furthermore, the cipher engine 305 determines whether or not to discard the contents key Kcont.

If the contents key Kcont is retained (YES in Step S160-63), in Step S160-65, the cipher engine 305 monitors whether or not there is such utilization as that the digital contents are determined to be utilized (for example, the case where music data is reproduced for a predetermined number of seconds or more).

If there is no such utilization as that the digital contents are determined to be utilized (NO in Step S160-65), the cipher engine 305 repeats the processing from Step S160-63.

If there is such utilization as that the digital contents are determined to be utilized (YES in Step S160-65), in Step S160-67, the cipher engine 305 confirms a license ID (LID) of license data LIC corresponding to the digital contents, and deletes the corresponding “(LC∥ADR∥P)” from the transfer log list.

Note that the processing of Steps S160-63 to S160-65 is repeatedly executed at regular intervals while the contents key Kcont is retained.

If the contents key Kcont is discarded (NO in Step S160-63) or after the processing of Step S160-61, in Step S160-69, the controller 301 determines whether or not the contents of the license data LIC received from the storage device 200 are required to be restored to a state before update involved in utilization of the digital contents.

Specifically, the controller 301 determines that the contents of the license data LIC are required to be restored to a state before update involved in utilization of the digital contents if there is no such utilization as that the digital contents are determined to be utilized. For example, if the contents reproduction device 300 does not reproduce digital contents at all corresponding to license data LIC for reproducing predetermined digital contents even though the device acquires the license data LIC from the storage device 200, or if reproduction is executed for such a short time as that is not determined as utilization, the controller 301 determines that the contents of the license data LIC are required to be restored.

If the contents of the license data LIC are required to be restored (YES in Step S160-69), in Step S160-71, the storage device 200 and the contents reproduction device 300 execute “restoration transfer processing”.

Note that contents of the “restoration transfer processing” in Step S160-71 are the same as those of the “restoration transfer processing” in Step S80. Specifically, the “restoration transfer processing” in Step S160-71 is executed if it is determined that the contents of the license data LIC are required to be restored during the “read transfer processing”.

If the contents of the license data LIC are not required to be restored (NO in Step S160-69), the controller 301 finishes the read transfer processing.

(5) Restoration Transfer Processing

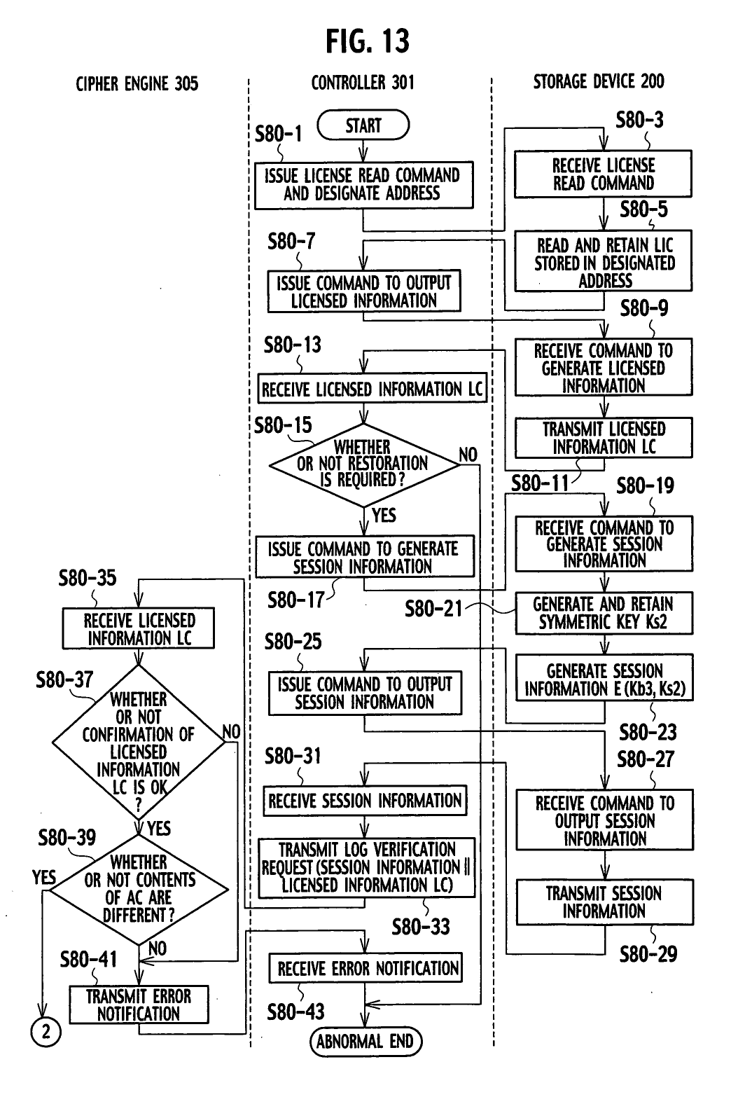

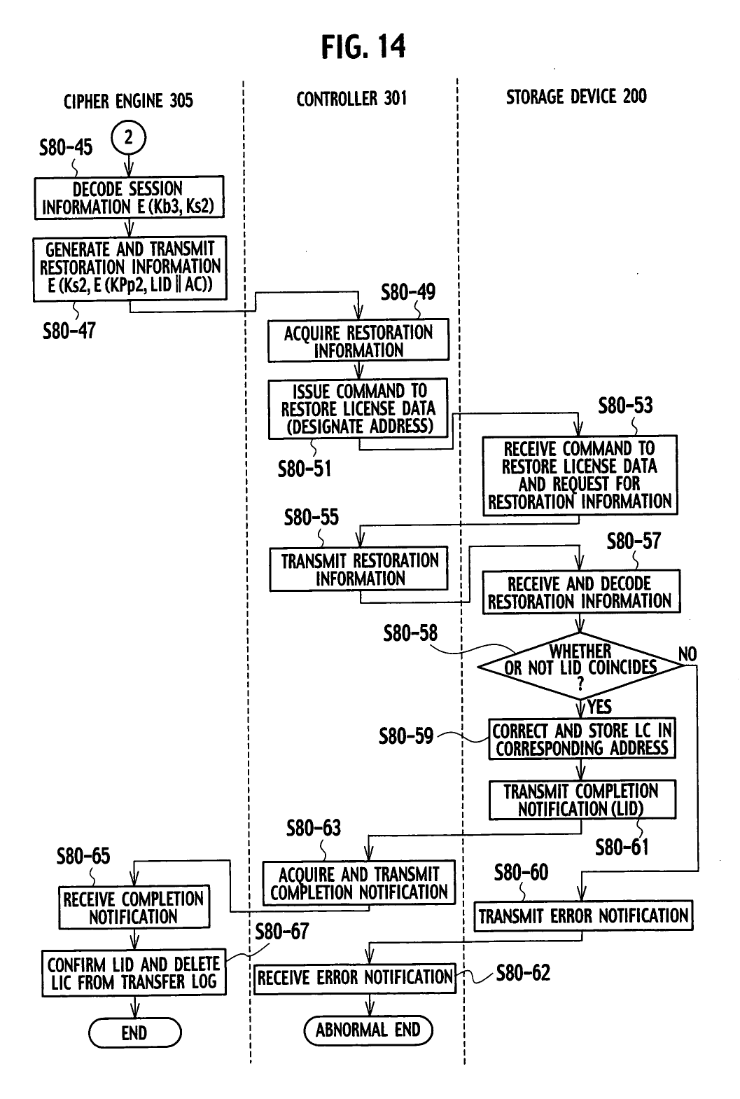

FIGS. 13 and 14 show contents of the restoration transfer processing in Step S80 described above. As shown in FIG. 13, in Step S80-1, the controller 301 refers to the transfer log list and issues to the storage device 200 a license read command to read the license data LIC stored in the storage device 200 (the tamper-resistant data storage unit 207). Moreover, the controller 301 designates an address of the tamper-resistant data storage unit 207 in which the license data LIC is stored.

In Step S80-3, the storage device 200 receives the license read command from the controller 301. In Step S80-5, the storage device 200 reads and retains the license data LIC stored in the designated address.

In Step S80-7, the controller 301 issues a command to output the licensed information LC to the storage device 200. In Step S80-9, the storage device 200 receives the command to output the licensed information LC from the controller 301.

In Step S80-11, the storage device 200 transmits the licensed information LC included in the license data LIC to the controller 301. In Step S80-13, the controller 301 receives the licensed information LC from the storage device 200.

In Step S80-15, based on the licensed information LC received from the storage device 200, the controller 301 determines whether or not the contents of the license data LIC are required to be restored to a state before update involved in utilization of corresponding digital contents.

Specifically, the controller 301 determines that it is required to restore the license data LIC if a license ID (LID) included in the licensed information LC received from the storage device 200 coincides with a license ID (LID) included in the licensed information LC to be determined and the contents of the usage rules AC included in the respective licensed information LC are different from each other. In other words, the controller 301 determines that it is required to restore the license data LIC if the read transfer processing is interrupted (the same license ID (LID) is included in the transfer log list) and the contents of the usage rule AC included in the license data LIC stored in the storage device 200 are updated by the previous transmission of the license data LIC (the contents of the usage rules AC included in the respective licensed information LC are different from each other).

If it is required to restore the license data LIC stored in the storage device 200 (YES in Step S80-15), in Step S80-17, the controller 301 issues a command to generate session information to the storage device 200.

If it is not required to restore the license data LIC stored in the storage device 200 (NO in Step S80-15), the controller 301 finishes the restoration transfer processing.

In Step S80-19, the storage device 200 receives the command to generate the session information from the controller 301.

In Step S80-21, the storage device 200 generates and retains a symmetric key Ks2. In Step S80-23, the storage device 200 uses the symmetric key Ks2 to generate the session information E(Kb3, Ks2).

In Step S80-25, the controller 301 issues a command to output the session information to the storage device 200. In Step S80-27, the storage device 200 receives the command to output the session information from the controller 301.

In Step S80-29, the storage device 200 transmits the session information E(Kb3, Ks2) to the controller 301. In Step S80-31, the controller 301 receives the session information from the storage device 200.

In Step S80-33, the controller 301 transmits a log verification request (session information∥licensed information LC) to the cipher engine 305. In Step S80-35, the cipher engine 305 receives the log verification request (specifically, licensed information LC included in the log verification request) from the controller 301.

In Step S80-37, the cipher engine 305 confirms contents of the licensed information LC received from the controller 301 and contents of the licensed information LC included in the transfer log list. Specifically, the cipher engine 305 determines whether or not the transfer log list includes licensed information LC having the same license ID (LID) as the license ID (LID) included in the licensed information LC received from the controller 301.

If the transfer log list includes the corresponding licensed information LC (YES in Step S80-37), in Step S80-39, the cipher engine 305 compares the contents of the usage rules AC included in the respective licensed information LC.

If the contents of the two usage rules AC are different from each other (YES in Step S80-39), in other words, if it is determined that the usage rule AC included in the license data LIC stored in the storage device 200 is updated by the previous transmission of the license data LIC, the cipher engine 305 shifts to processing of Step S80-45 shown in FIG. 14.

If the transfer log list does not include the corresponding licensed information LC (NO in Step S80-37) and if the two usage rules AC coincide with each other and it is determined that the contents thereof are not updated (NO in Step S80-39), in Step S80-41, the cipher engine 305 transmits to the controller 301 an error notification indicating that the license data LIC cannot be restored.

In Step S80-43, the controller 301 receives the error notification from the cipher engine 305 and finishes the restoration transfer processing as an abnormal end.

Next, as shown in FIG. 14, in Step S80-45, the cipher engine 305 decrypts the received session information E(Kb3, Ks2) and takes out the symmetric key Ks2.

In Step S80-47, the cipher engine 305 generates restoration information E(Ks2, E(KPp2, LID∥AC)) obtained by encrypting LID∥JAC by use of the symmetric key Ks2 and the public key KPp3 of the storage device 200, and transmits the generated restoration information E(Ks2, E(KPp2, LID∥AC)) to the controller 301. In Step S80-49, the controller 301 receives the restoration information E(Ks2, E(KPp2, LID∥AC)) from the cipher engine 305.

In Step S80-51, the controller 301 issues a command to restore the license data LIC to the storage device 200. Moreover, the controller 301 designates a storage destination address of the license data LIC in the storage device 200 (the tamper-resistant data storage unit 207) and notifies the storage device 200 of the address.

In Step S80-53, the storage device 200 receives the command to restore the license data LIC from the controller 301. The storage device 200 requires the controller 301 to transmit the restoration information E(Ks2, E(KPp2, LID∥AC)) based on the command.

In Step S80-55, the controller 301 transmits the restoration information E(Ks2, E(KPp2, LID∥AC)) to the storage device 200.

In Step S80-57, the storage device 200 receives the restoration information E(Ks2, E(KPp2, LID∥AC)) from the controller 301. Furthermore, the storage device 200 uses the private key Kp2 and the symmetric key Ks2 to decrypt E(Ks2, E(KPp2, LID∥AC)) and takes out the license ID (LID) and the usage rule AC.

In Step S80-58, the storage device 200 determines whether or not the license ID (LID) included in the license data LIC stored in the address designated by the controller 301 coincides with the license ID (LID) taken out by decrypting E(Ks2, E(KPp2, LID∥AC)).

If the license IDs (LIDs) do not coincide (NO in Step S80-58), in Step S80-60, the storage device 200 determines that the restoration information E(Ks2, E(KPp2, LID∥AC)) is not reliable information, and transmits to the controller 301 an error notification indicating that processing to respond to the command to restore the license data LIC is not to be executed.

In Step S80-62, the controller 301 receives the error notification from the storage device 200 and finishes the restoration transfer processing as an abnormal end.

Meanwhile, if the license IDs (LIDs) coincides with each other, in Step S80-59, the storage device 200 rewrites the usage rule AC included in the license data LIC stored in the address designated by the controller 301 into the usage rule AC taken out of the restoration information. In this event, the license data LIC stored in the address is set in a state of being allowed to be outputted.

The usage rule AC taken out of the restoration information is the usage rule AC before the previous transmission of the license data LIC. The rewrite of the usage rule AC restores the license data LIC to a state before transmission thereof. Note that, as to the setting of the license data LIC in the state of being allowed to be outputted, since the data is set in a state of being not allowed to be outputted if transmission of the license data LIC is move, the license data LIC is restored to the state before transmission thereof.

Thus, regardless of the utilization types including playback (reproduction), copy and move, the license data LIC can be restored to the state before transmission thereof. Therefore, for restoration, the storage device 200 is not required to record the utilization type of the license data LIC in the previous transmission.

In Step S80-61, the storage device 200 transmits to the controller 301 a completion notification indicating that the rewrite of the usage rule AC is completed. Note that the completion notification includes the license ID (LID).

In Step S80-63, the controller 301 acquires the completion notification transmitted by the storage device 200 and transmits the acquired completion notification to the cipher engine 305. In Step S80-65, the cipher engine 305 receives the completion notification from the controller 301.

In Step S80-67, the cipher engine 305 confirms the license ID (LID) included in the received completion notification, deletes the license data LIC having the license ID (LID) from the transfer log list, and finishes the restoration transfer processing.

(Operation/Effect)

According to the contents utilization system 10 of the embodiment described above, if it is determined that digital contents are not utilized by the contents reproduction device 300 even though the right to utilize the digital contents is acquired, the contents reproduction device 300 requests the storage device 200 to restore the license data LIC received from the storage device 200 to the state before update thereof.

Moreover, the storage device 200 determines whether or not the contents of the transfer log list received from the contents reproduction device 300 along with the restoration request coincide with the updated and stored license data LIC, and restores the license data LIC to the state before update thereof.

Specifically, according to the aspect described above, if the digital contents are not properly utilized by use of the license data LIC transmitted by the storage device 200, the contents of the license data LIC managed by the storage device 200 can be restored to the state before transmission thereof.

Moreover, according to the contents utilization system 10, even if the communication connection is cut off due to interruption of transmission and reception of the license data LIC (the usage rule AC), the processing of restoring the contents of the license data LIC to a state before transmission thereof is executed after the communication connection is reestablished by use of the symmetric key (Kb2old and Kb3old) that is a temporary key which is used for transmission and reception of the license data LIC and is temporarily generated (refer to the reconnection processing described above).

Specifically, even after the communication connection is cut off, the other device to and from which the license data LIC is transmitted and received can be surely specified by use of the symmetric key (Kb2old and Kb3old) used in the cut communication connection. Thus, such restoration of the license data LIC as to exceed the range allowed by the right to utilize the digital contents, such as spoofing of the contents reproduction device 300, is prevented. Consequently, it is possible to protect the rights of those who created the digital contents (copyrights and the like) while improving convenience for users of the digital contents.

### Other Embodiments

As described above, the contents of the present invention have been disclosed through one embodiment of the present invention. However, it should be understood that the present invention is not limited to the description and drawings which constitute a part of this disclosure. From this disclosure, various alternative embodiments will become apparent to those skilled in the art.

For example, in the above-described embodiment of the present invention, the license data LIC transmitted by the storage device 200 is set to be E(Ks3, E(KPp3, LIC)) which is encrypted by use of the public key KPp3 and further encrypted by use of the symmetric key Ks3. However, the order of the encryption is not limited thereto.

For example, the order of the encrypting may be reversed to E(KPp3, E(Ks3, LIC)). In this case, the same encrypting strength as that of E(Ks3, E(KPp3, LIC)) can also be obtained. Furthermore, similarly, the restoration information E(Ks2, E(KPp2, LID∥AC)) may be set to E(KPp2, E(Ks2, LID∥AC)).

In the above-described embodiment of the present invention, the symmetric keys Ks2 and Ks3 are transmitted, as the session information E(Kb2, Ks3) and E(Kb3, Ks2), by single encryption. However, as in the case of the license data LIC and the restoration information, the symmetric keys can also be double-encrypted. For example, the session information may be set to E(Kb2, E(Kb3, Ks3)), E(Kb3, E(Kb2, Ks2)) and the like.

In the above-described embodiment of the present invention, when the communication connection is established, the symmetric keys Kb2 and Kb3, which are shared by the storage device 200 and the cipher engine 305, are continuously used for generation of the session information. However, the symmetric keys may be updated every time the encrypted license data LIC or the restoration information is transmitted and received.

In this case, as the symmetric keys Kb2 and Kb3, the most recently used symmetric keys Ks2 and Ks3 (hereinafter referred to as Ks2old and Ks3old) may be used.

If the session information E(Ks2old, Ks3) and E(Ks3old, Ks2) is double-encrypted, the session information is set to E(Ks2old, E(Ks3old, Ks3)) and E(Ks3old, E(Ks2old, Ks2)). Moreover, as the first Ks2old and Ks3old, the symmetric keys Kb2 and Kb3 may be used.

In the above-described embodiment of the present invention, the communication connection is reestablished by use of the symmetric keys Kb2old and Kb3old which are temporary keys generated when the communication connection is established. However, the symmetric keys may not necessarily be used. Any kind of temporary keys may be used as long as they are temporary keys temporarily generated when or after the communication connection is established.

In the above-described embodiment of the present invention, the description was mainly given of the processing between the storage device 200 and the contents reproduction device 300. However, the present invention can also be applied to processing between the storage device 200 and the contents recording device 100.

In the above-described embodiment of the present invention, the description was given of the case of reproduction (playback) of digital contents, as an example. However, the present invention can also be applied to replication (copy) of the digital contents or transfer (move) of license data LIC to another recording medium.

In the above-described embodiment of the present invention, the description was given of the case where the music data is used as the digital contents. However, the present invention is not limited to the music data but can be applied to various multimedia information including video data (still images and moving images), programs such as games, documents, and the like.

Moreover, the logical blocks (the controller 201, the cipher engine 205, the controller 301 and the cipher engine 305) according to the present invention can also be provided as programs which can be executed by a personal computer and the like.

As described above, needless to say, the present invention includes various embodiments and the like which are not described here. Therefore, the technical scope of the present invention is determined only by the items specific to the invention according to the scope of claims appropriate based on the above description.

What is claimed is:

1. A contents utilization system comprising:
a contents utilization device which utilizes encrypted digital contents with a contents utilization information including a contents key for decrypting the encrypted digital contents and a usage rule for the encrypted digital contents; and
a contents utilization information storage device which stores the contents utilization information and updates the usage rule of the stored contents utilization information according to output of the stored contents utilization information to the contents utilization device, wherein
the contents utilization device includes:
a log storage unit which stores a contents utilization information identifier for identifying the contents utilization information and the usage rule;
a utilization determination unit which determines whether or not the digital contents are utilized; and
a restoration request unit which requests restoration of the stored contents utilization information to a state before update thereof if the utilization determination unit determines that the digital contents are not utilized and transmits the contents utilization information identifier and the usage rule, both of which are stored in the log storage unit, to the contents utilization information storage device, and
the contents utilization information storage device includes:
a rewrite determination unit which determines whether or not to rewrite the stored contents utilization information based on whether or not the contents utilization information identifier transmitted from the restoration request unit coincides with the contents utilization information identifier included in the stored contents utilization information; and
a rewrite unit which rewrites the usage rule included in the stored contents utilization information into the usage rule transmitted by the restoration request unit based on a result of determination by the rewrite determination unit.

2. The contents utilization system of claim 1, wherein the rewrite unit changes the stored contents utilization information into a state where output is allowed together with rewrite of the usage rule, in either state where output of the stored contents utilization information is allowed or prohibited before the rewrite of the usage rule.

3. The contents utilization system of claim 1, wherein
the contents utilization device further includes a utilization device side cipher processor which encrypts a TX information transmitted to and decrypts an RX information received from the contents utilization information storage device,
the contents utilization information storage device further includes a storage device side cipher processor which encrypts the RX information transmitted to and the TX information received from the contents utilization device, and generates a storage device side temporary key, and
the contents utilization information identifier and the usage rule, both of which are encrypted by use of the storage device side temporary key are transmitted from the contents utilization device to the contents utilization information storage device.

4. A contents utilization device which utilizes digital contents by receiving a contents utilization information including a usage rule for the digital contents from a contents utilization information storage device which stores the contents utilization information and updates the usage rule of the stored contents utilization information according to output of the stored contents utilization information, the contents utilization device comprising:
a log storage unit which stores a contents utilization information identifier for identifying the contents utilization information and the usage rule;
a utilization determination unit which determines whether or not the digital contents are utilized; and
a restoration request unit which requests restoration of the stored contents utilization information to a state before update thereof if the utilization determination unit determines that the digital contents are not utilized, and transmits the contents utilization information identifier and the usage rule, both of which are stored in the log storage unit, to the contents utilization information storage device.

5. The contents utilization device of claim 4, further comprising:
a utilization device side cipher processor which encrypts a TX information transmitted to and decrypts an RX information received from the contents utilization information storage device, wherein
the contents utilization information identifier and the usage rule, both of which are encrypted with a temporary key that is temporarily generated in the contents utilization information storage device, are transmitted to the contents utilization information storage device.

6. A contents utilization information storage device which stores a contents utilization information including a usage rule for digital contents and updates the usage rule of the stored contents utilization information according to output of the stored contents utilization information to a contents utilization device which utilizes the digital contents, the contents utilization information storage device comprising:
a rewrite determination unit which receives a contents utilization information identifier for identifying the contents utilization information transmitted from the contents utilization device, and determines whether or not to rewrite the stored contents utilization information based on whether or not the received contents utilization information identifier coincides with the contents utilization information identifier included in the stored contents utilization information; and
a rewrite unit which rewrites the usage rule included in the stored contents utilization information into the usage rule transmitted from the contents utilization device, based on a result of determination by the rewrite determination unit.

7. The contents utilization information storage device of claim 6, wherein the rewrite unit changes the stored contents utilization information into a state of where output is allowed together with rewrite of the usage rule, in either state where output of the stored contents utilization information is allowed or prohibited before the rewrite of the usage rule.

8. The contents utilization information storage device of claims 6, further comprising:
a storage device side cipher processor which encrypts a TX information transmitted to and an RX information received from the contents utilization device and generates a temporary key, wherein
the usage rule encrypted with the temporary key is transmitted from the contents utilization device.
